(19) United States
(12) Patent Application Publication
(10) Pub. No.: US 2007/0271894 A1
(43) Pub. Date: Nov. 29, 2007

(54) The Bauer Blade

(76) Inventor: Steve Bauer, Kurtistown, CA (US)

Correspondence Address: CRAIG A. SIMMERMON, 251 LYMAN CIR., SACRAMENTO, CA, 95835, US

(21) Appl. No.: 11/308,932

(22) Filed: May 26, 2006

(51) Int. Cl. A01D 34/00

(52) U.S. Cl. 56/12.7

(57) ABSTRACT

The Bauer Blade is a lawn mower blade used to cut vegetation. The invention is the first inexpensive, molded or die cast, replacement blade for a conventional lawnmower that will not harm the operator who inadvertently places body parts within the mower cavity, without sacrificing performance of the lawnmower blade. The invention is inexpensive because it is, essentially, a one-piece molded or die cast apparatus. Additionally, the invention will not harm bystanders because the blade does not produce dangerous high speed projectiles.

### BACKGROUND OF INVENTION

Conventional metal lawnmower blades are prone to problems related to human injury, property damage, lawnmower maintenance, air pollution, fuel economy, and the inherent requirement for second-operation edge trimming.

The Bauer Blade uses a flexible cutting material as its “blade” that will not penetrate shoes or work gloves. Conversely, conventional lawnmower blades may penetrate into feet, hands, and other human tissue, even when shoes or gloves are worn by the operator. In fact, conventional lawnmower blade injuries are often of the appendage amputation type because of the conventional lawnmower blade's machete-like structure.

Additionally, the flexible blade material of the Bauer Blade is many times lighter than the blade material of a conventional lawnmower blade. This greatly reduces momentum transfer from the blade to objects in the lawn. Objects in the lawn include intended targets such as vegetation as well as foreign objects such as debris located in the lawn not intended to be struck by the blade. When a conventional lawnmower blade strikes a foreign object, the blade typically knocks the foreign object into motion at a high rate of speed. This activity frequently results in projectiles shooting out from the lawnmower which can cause significant human injury and property damage. The Bauer Blade, conversely, does not initiate large enough momentum transfer to produce high-speed dangerous projectiles. Consequently, the Bauer Blade significantly reduces the production of dangerous projectiles and the injuries resulting therefrom. These two safety factors alone, protection from direct blade injury and from indirect projectile injury, provide very significant advantages over conventional lawnmower blades.

Maintenance is another advantage. Conventional lawnmower blades require sharpening, which typically requires removal of the blade from the lawnmower, drop-off time at a sharpening service provider, and then reinstallation of the blade. Sharpening is necessitated by normal wear from cutting vegetation or by collision with foreign objects. The Bauer Blade never needs sharpening. Unlike conventional lawnmower blades, the Bauer Blade typically can be “renewed” in less than five minutes, without tools or downtime. Renewal is required annually or more typically biannually, depending on frequency of use, toughness of the vegetation, and toughness of the particular flexible cutting material used in the Bauer Blade. Renewal is the replacement of worn flexible cutting material with new flexible cutting material.

Conventional lawnmower blades cause damage to uneven ground, tree roots, garden hoses, sprinkler heads, toys and other valuable items that may be on the lawn or in its vicinity. The Bauer Blade will not damage these items because the flexible cutting material skims right over these items without scalping or cutting. The same flexibility in the cutting material that prevents the Bauer Blade from injuring human tissue also prevents property damage on a scale uncommon to conventional metal lawnmower blades.

Moreover, the shape of the Bauer Blade has advantages over the shape of conventional lawnmower blades. The Bauer Blade is essentially a large disc (see FIG. 1 and claim 1) that does not readily transfer momentum to targets in the lawn and therefore does not incur large drag forces during rotation. This behavior is summed up by the application of Newton's third law to the particular dynamics at hand—large momentum transfer from conventional blade to target yields large drag forces on the conventional blade, conversely, small momentum transfer from Bauer Blade to target yields small drag forces on Bauer Blade. The Bauer Blade experiences drag primarily only from its lightweight flexible cutting material passing through the target area. A conventional blade, on the other hand, is essentially two heavy rigid spinning knives that incur drag forces across the full length of the knife-like structure. The cutting portions of conventional blades are extremely heavy as compared to the weight of the vegetation for which the blade is used to cut. This enormous weight difference is not required for successful cutting and is, in fact, detrimental to safety, property damage, maintenance, air pollution, and fuel economy of the mower because of the large degree of momentum transfer between the blade and its targets.

Also, conventional metal lawnmower blades require significantly more energy to keep in rotational motion. The Bauer Blade, on the other hand, uses much less energy to sustain rotation, which yields advantages in fuel consumption, air pollution, and provides better application for electrically powered lawnmowers. Thus, the heavy girth of a conventional blade is detrimental in other ways as well.

### BRIEF DESCRIPTION OF THE DRAWINGS

Typical embodiments of the present invention are illustrated in the accompanying drawings which are not to be limiting of the invention's scope in which:

FIG. 1 is a perspective view of Bauer Blade.

FIG. 1A is a longitudinal section of the Bauer Blade.

FIG. 2 is a depiction of bent string attachment means.

FIG. 3A is a depiction of camlock string attachment means.

FIG. 3B is a depiction of mushroom string attachment means.

FIG. 3C is a depiction of knot string attachment means.

FIG. 4 is a depiction of the Bauer Mower.

### DEFINITION LIST

| Term | Definition |
|---|---|
| 10 | Bauer Blade |
| 20 | Disc |
| 30 | Flexible string |
| 40 | Location of blade shaft holes |
| 50 | Location of string attachment means |
| 60 | Overall disc radius |
| 70 | Camlock |
| 80 | Mushroom |
| 90 | Knot |
| 100 | Center line of blade shaft |

### DETAILED DESCRIPTION OF INVENTION

A Bauer Blade 10 can serve as a replacement blade for a conventional lawnmower blade on a standard one-blade lawnmower or on multi-blade mowers such as riding lawnmowers or wide-cutting walk behind mowers.

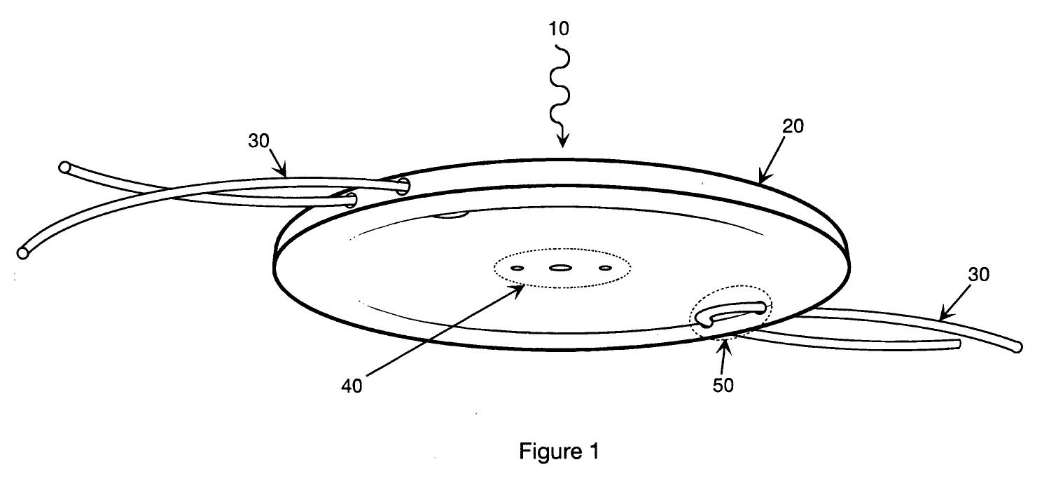

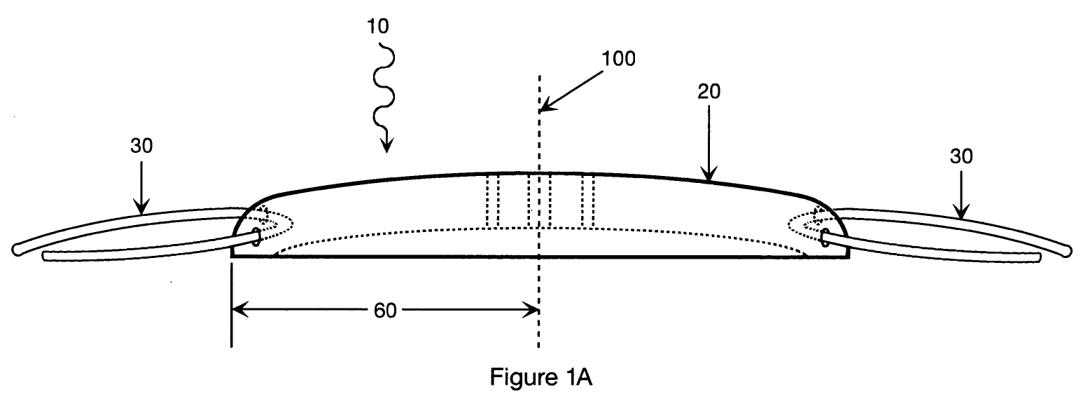

The preferred embodiment of the invention is depicted in FIG. 1. Most lawnmowers have a single blade shaft with threaded female end at which point a blade is reversibly secured thereto with a washer and bolt. In this instance, the Bauer Blade is attached to the blade shaft through the center hole at 40 using a washer and bolt. Other lawnmowers have a blade shaft with two female thread locations, as with the currently manufactured Honda brand lawnmowers. In this instance, the Bauer Blade is attached to the blade shaft through the two holes located on opposite sides of the center hole at 40 using two washers and two bolts.

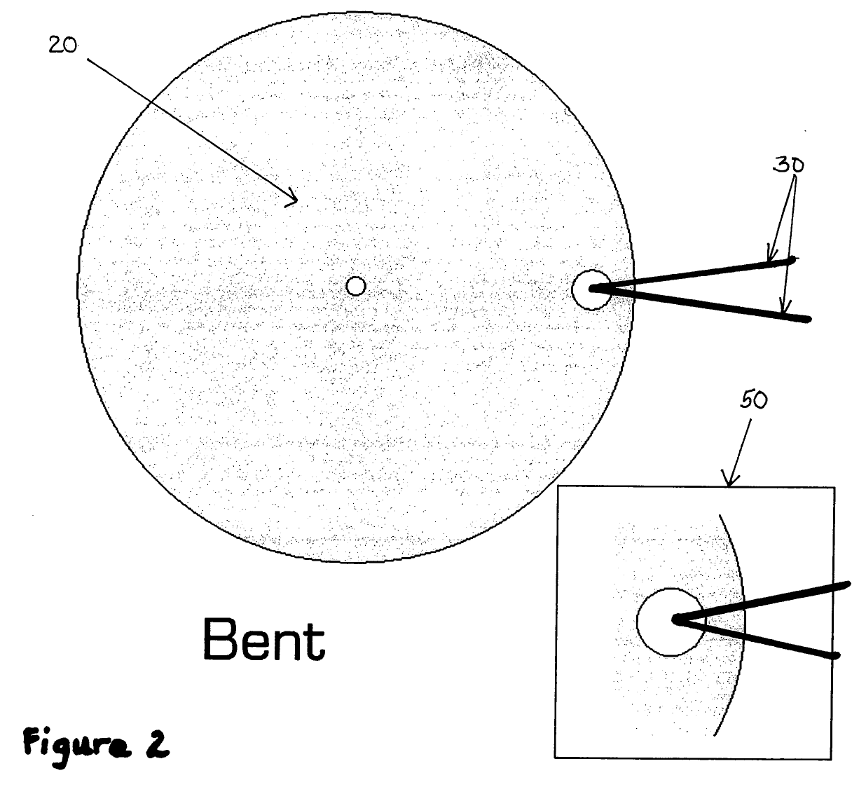

The preferred embodiment of string attachment means (see claim 1) is depicted in FIGS. 1, 1A, and 2. This string attachment means is called bent string attachment means. The string 30 is simply bent into a V-shape and then inserted into the two string holes at 50. FIGS. 1 and 1A depict the invention with two strings 30 attached to the disc 20 and is the preferred embodiment. There are two holes in the disc 20 at each string attachment location 50 with the bent string attachment means. Therefore, the preferred embodiment as depicted in FIGS. 1 and 1A contains four string holes and two attached strings 30.

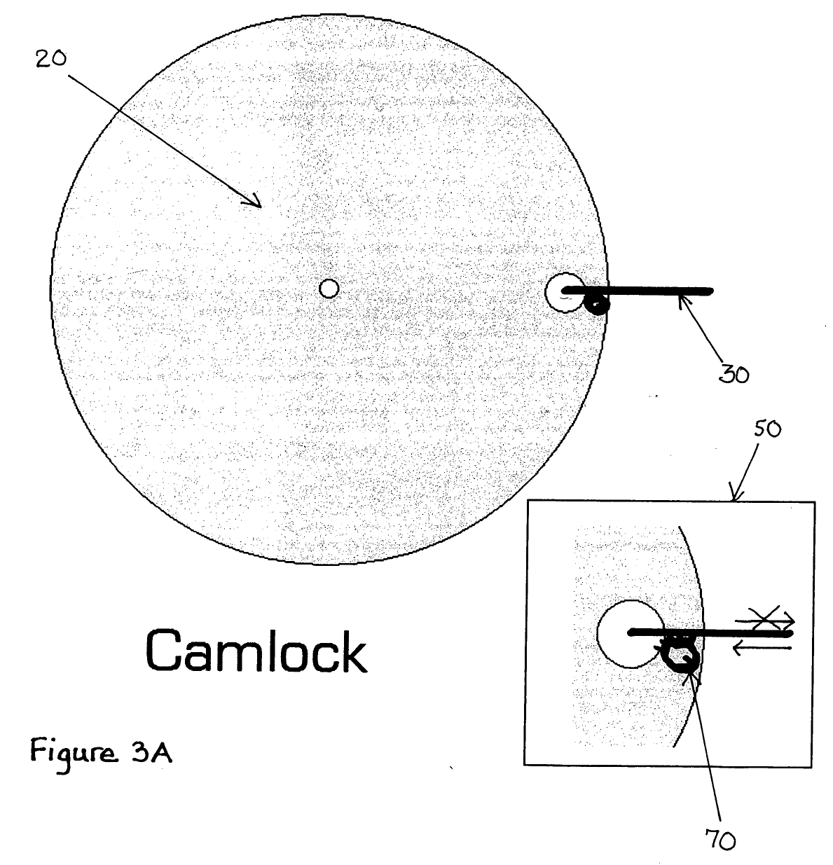

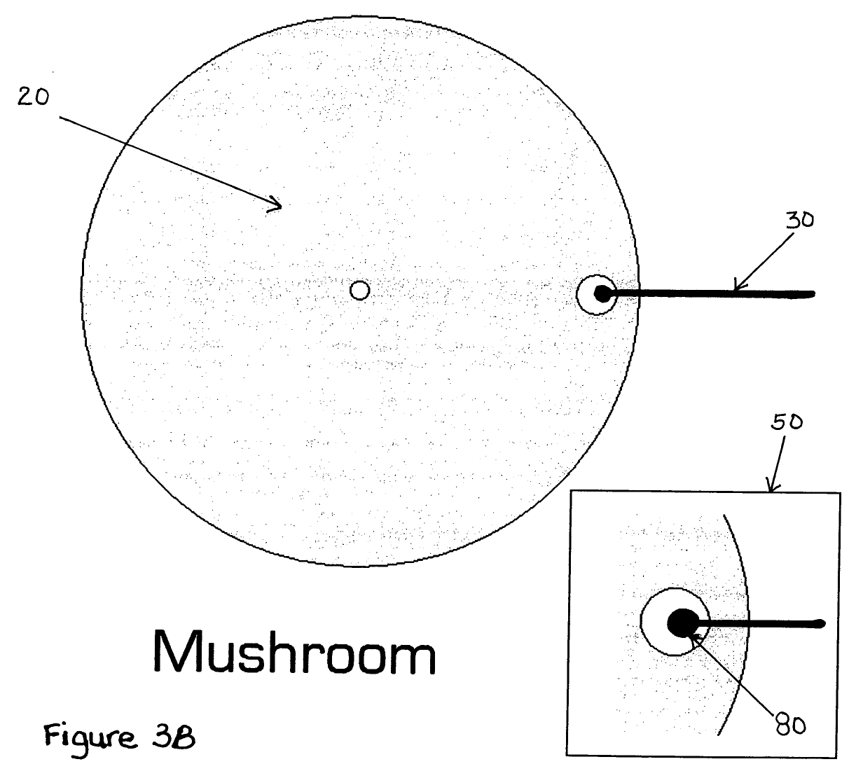

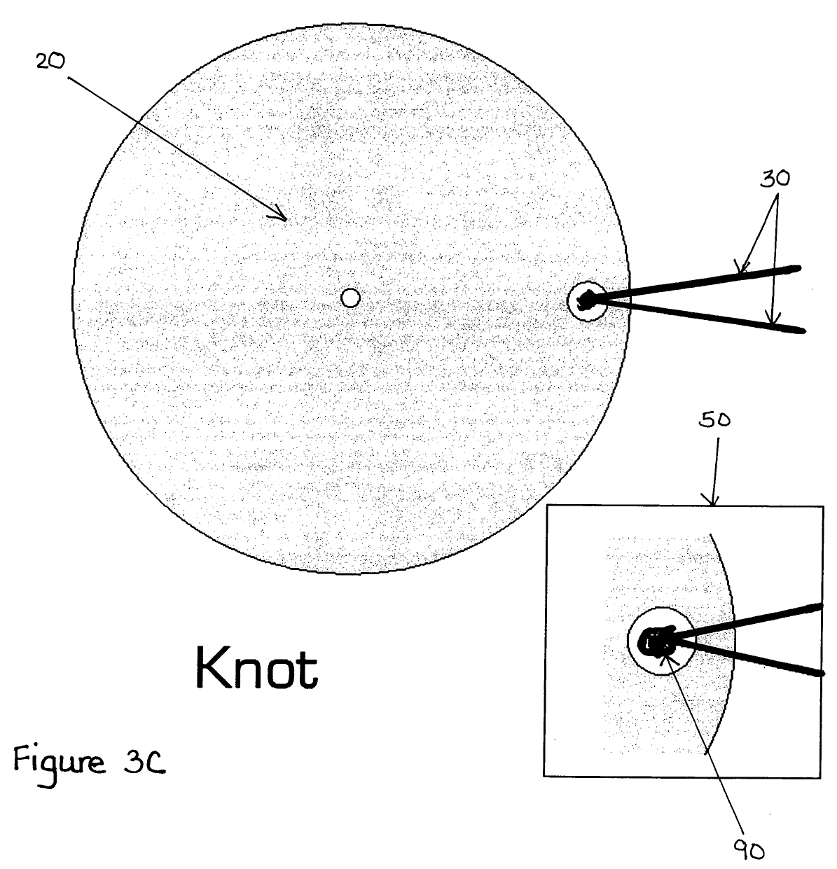

Another string attachment means is depicted in FIG. 3A. The camlock string attachment means includes a ratchet mechanism or camlock 70 that allows the string 30 to be inserted from the outer direction of the disc 20 and slid into a camlock 70. The camlock 70 then grabs the string 30 and prevents it from moving outwardly from the disc 20. With this string attachment means, the string 30 is removed by further pushing the string 30 inward until it is completely slid through the camlock 70. This string attachment means has application with heavier and less flexible string material.

Another string attachment means is depicted in FIG. 3B. The mushroom means uses one hole per string attachment means where the string 30 is slid into the disc 20 from the inward side of the disc 20. The string 30 is held in place by centrifugal force on the bulbous portion or mushroom 80 of the string 30. The string 30 is supplied with the mushroom 80 already formed on the string 30 with this string attachment means.

Another string attachment means is depicted in FIG. 3C. This is the knot means. In this instance the string 30 is bent into a U-shape and knotted at 90 at the base of the U. Each leg of the U is then fed into a string hole from the inward direction of the disc 20. This string attachment means is similar to the preferred embodiment, the bent string attachment means, but in this case the string 30 is knotted at 90 to provide additional assurance that the string 30 will not slide out off of the disc 20. This string attachment means may have application with more flexible smaller diameter string 30.

FIGS. 2, 3A, 3B, and 3C all depict one string 30 per disc 20. However the preferred embodiment is to have two strings 30 per disc 20.

The disc 20 needs to be balanced to ensure proper rotation at the typical rotations-per-minute of lawnmower motors without wobbling or unsteady rotation. Balancing also requires that a Bauer Blade have similar overall weight to that of the conventional metal blade for which the Bauer Blade is to replace. This requirement translates to sizing requirements for the Bauer Blade. Die-casted or molded Bauer Blades should have an overall radius of the disc 60 of 40-60% of the “internal blade cavity radius” measurement. The “internal blade cavity radius” measurement is specific to a particular lawnmower model and is defined as distance between the center-line of the blade shaft 100 and the inside diameter of the mower housing or, in the case of multi-blade mowers, the distance between the center-line of blade shaft 100 and the outer diameter of the next closest adjacent blade. An overall disc radius 60 of essentially one half the internal blade cavity radius measurement is the preferred embodiment. Thus, with the preferred embodiment, the string 30 length would also equal essentially half of the internal blade cavity radius measurement. With the preferred embodiment, the distance between the center-line of the blade shaft 100 and inside diameter of the mower housing should essentially be divided in two equal sections: half disc and half string. The same proportions should be used when fitting multi-blade mowers with the preferred embodiment of the Bauer Blade, i.e. the distance between the blade shaft center-line 100 and the outer diameter of the next closest adjacent blade should essentially be half disc and half string.

When renewing the flexible cutting string, one need only add new string 30 with excess length and the Bauer Blade will self-correct the string 30 length by wearing away excess string 30 against the mower housing. This technique should also be applied when renewing flexible string material on multi-blade lawnmowers. In this case, the string 30 length self-corrects against the string 30 on the next closest adjacent Bauer Blade and vice versa.

Despite that only round cross-sectional flexible cutting material is depicted in the drawings, the flexible cutting material or string 30 of the Bauer Blade may be of a non-round cross-sectional geometric shape to provide more efficient vegetation cutting. The preferred embodiment of the invention is a round cross-sectional shape because round cutting line is readily available and is extremely cost effective.

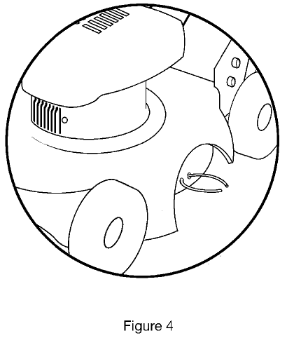

When installed into an appropriately designed lawnmower, the Bauer Blade, as depicted in FIG. 4, allows the lawn to be mowed and trimmed in the same operation. This type of mower, the Bauer Mower, is a complement to the Bauer Blade. With the flick of a switch, the Bauer Mower exposes a portion of the Bauer Blade to the open air outside of the mower housing. The Bauer Mower can be maneuvered carefully around trees, curbing, sidewalks, driveways, and other items so that the Bauer Blade passes around objects in the lawn in a similar manner to the movement of a conventional weed-whacker string edge trimmer around these items. Hence, the Bauer Mower can mow and edge-trim in one operation, thereby saving all additional labor involved in the secondary trimming operation. Because of the lower drag forces associated with the Bauer Blade, the Bauer Mower, equipped with the Bauer Blade, is much better suited for clean electric power than standard mowers with conventional metal blades.

Note that FIG. 4 depicts the Bauer Mower with housing opening on the right side of the mower housing. This opening could be placed on the left side as well. The best mode for the Bauer Mower is to have the opening on the left. Also note that FIG. 4 does not depict a closing mechanism which would open and close the “trimming section” of the mower housing. The mower housing would only be opened for trimming and would be closed thereafter by the Bauer Mower operator. This open/close mechanism is added for safety purposes and is the preferred embodiment of the Bauer Mower.

1. Apparatus used for cutting, comprising: a disc with central attachment means to attach to a blade shaft of a lawnmower; one or more flexible strings used for cutting; and a string attachment means to attach said string(s) to said disc.

2. Apparatus as in claim 1 wherein said string is made of plastic or other similarly flexible material with cross-sectional geometrical shape having outer diameter ranging from 0.050″ to 0.200″.

3. Apparatus as in claim 2 wherein said string is made of plastic, metal, glass, talc, or any combination thereof.

4. Apparatus as in claims 1, 2, or 3 wherein said disc is made primarily of metal, plastic, carbon fiber, ceramic, fiberglass, or any combination thereof.

5. (canceled)

6. (canceled)

7. (canceled)

8. (canceled)

9. A lawnmower with an opening in the lawnmower blade cavity housing that exposes the lawnmower blade to the air outside of the lawnmower blade cavity housing wherein said lawnmower blade is an apparatus according to any of the preceding claims.
